(19) United States
(12) Patent Application Publication
(10) Pub. No.: US 2008/0099658 A1
(43) Pub. Date: May 1, 2008

(54) LENS RELEASE WITH PERIMETER STAMP

(76) Inventors: Vandana Srinivas, Jacksonville, FL (US); Stephen R. Beaton, Jacksonville Beach, FL (US); Stephen C. Pegram, Fruit Cove, FL (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/865,282

(22) Filed: Oct. 1, 2007

Related U.S. Application Data
(60) Provisional application No. 60/863,683, filed on Oct. 31, 2006.

(51) Int. Cl. B29D 11/00

(52) U.S. Cl. 249/114.1; 264/2.6

(57) ABSTRACT

The present invention includes methods and appartus for facilitating release of an ophthalmic lens from a mold part used to fashion the lens. Subsequent to formation of the lens, the lens may be adhered to the mold part and a lens swelling substance is utilized to cuase a portion of the lens to separate from the mold part and create a pathway for a hydration solution to enter between teh lens and the mold part an effect release of the lens.

### FIELD OF THE INVENTION

This invention relates to methods and apparatus for employing a lens swelling agent to assist in the release of a molded article from a mold part during molding of polymeric articles; such as, ophthalmic lenses. In particular, a lens swelling agent is applied in the form of a film or coating on a surface portion of a mold part defining a perimeter around a molded article.

### BACKGROUND OF THE INVENTION

It is well known that contact lenses can be used to improve vision. Various contact lenses have been commercially produced for many years. Early designs of contact lenses were fashioned from hard materials. Although these lenses are still currently used in some applications, they are not suitable for all patients due to their poor comfort and relatively low permeability to oxygen. Later developments in the field gave rise to soft contact lenses, based upon hydrogels.

Hydrogel contact lenses are very popular today. These lenses are often more comfortable to wear than contact lenses made of hard materials. Malleable soft contact lenses can be manufactured by forming a lens in a multi-part mold where the combined parts form a topography consistent with the desired final lens.

During typical ophthalmic lens manufacturing processes, a front curve mold part and a back curve mold part are injection molded. A reaction mixture that includes a monomer or prepolymer is dosed into one of the mold parts, such as, for example, the front curve mold part. The back curve mold is coupled with the front curve to enclose the reaction mixture into a cavity defining an appropriate lens geometry. This assembly is exposed to a polymerizing condition, such as for example, actinic radiation, which causes the monomer to polymerize and thereby create an ophthalmic lens.

Following polymerization, a demold process is used to separate the back curve mold part from the front curve mold part with the lens typically remaining adhered to the front curve mold part. The lens and front curve mold part are then exposed to a release process, such as exposure to a hydration fluid to release the lens from the front curve mold.

With the advent of silicone based monomers, release from the front curve mold part typically involves exposing the lens and front curve mold part to an organic solvent, such as isopropyl alcohol. The exposure typically involves submersion in the organic solvent or placement in a stream of the organic solvent. The organic solvents are used to swell the lens and facilitate release from the front curve mold part. Aqueous solutions, although sometimes effective, often require more time than desired in a modern manufacturing environment. However, organic solvents are often explosive and pose environmental risk, as well as added cost to a manufacturing process.

Therefore, it would be advantageous to provide apparatus and methods, which facilitate release of a formed lens from a mold part used to fashion the lens without the necessity of exposing the lens and front curve mold part to an organic solvent.

### SUMMARY OF THE INVENTION

Accordingly, the present invention provides improved release of lens adherence to a front curve mold part by application of a lens swelling substance around a perimeter of the lens. The lens swelling substance is applied in the form of a film or coating on the front curve mold part flange subsequent to mold separation, sometimes referred to as demold. IN some embodiments, the application of the lens swelling substance can be accomplished, for example with a stamping mechanism.

According to the present invention, TPME, or other lens swelling diluent, or lens swelling substance, is applied around a circumference of a formed lens while the lens remains adhered to a mold part. The swelling in the lens caused by the lens swelling substance allows a hydration solution to enter in between the lens and the mold part to which it is adhered and thereby facilitate lens release.

### DESCRIPTION OF THE DRAWINGS

FIG. 1 illustrates a diagram of an ophthalmic lens mold assembly.

FIG. 1A illustrates a diagram of an ophthalmic lens mold assembly with a formed lens and HEMA ring.

FIG. 1B illustrates a lens with a perimeter portion swelled and separated from the mold portion.

FIG. 2 illustrates a flow diagram of method steps that may be implemented according to some embodiments of the present invention.

FIG. 3 illustrates a block diagram of apparatus that may be used to implement some embodiments of the present invention.

FIG. 4 illustrates a top down view of an ophthalmic lens mold part.

FIG. 5 illustrates a perspective view of a scalloped lens in a mold part.

FIG. 6 illustrates an arc of separation of a lens from a mold part.

### DETAILED DESCRIPTION OF THE INVENTION

Generally, the present invention is directed to methods and apparatus for application of a lens swelling substance, such as TPME, to a lens edge circumference area of a mold part used to form an ophthalmic lens. The lens swelling substance can be applied, for example, via a stamp or other mechanized or manual means. Typically, a cast manufactured lens will create a hydrophobic water tight seal between the lens and a mold part used to fashion the lens. According to the present invention, a pathway is created which allows a hydration solution, such as an aqueous solution, between the surface of the lens and the corresponding surface of the mold. The pathway is created by exposing a portion of the lens to a lens swelling substance. In some preferred embodiments, the portion of the lens exposed is a circumferential edge around a perimeter of the lens forming surface of the mold.

In some preferred embodiments, the lens swelling substance includes TPME and the TPME is applied with a stamp on a flange area of the mold which allows the TPME to then flow into contact with the lens attached to the mold part. The TPME stamp results in a scalloped edge of the ophthalmic lens which in turn allows hydration solution to flow between the ophthalmic lens and the mold part, thereby facilitating release of the ophthalmic lens from the mold part.

The lens swelling material can include for example a solution of 100% TPME or a diluted form of TPME, such as, for example, an aqueous solution of 0.1% to 15% or between 0.1% to 5% TPME.

Methods and apparatus for applying a lens swelling substance to a mold surface are well known and described, for example in U.S. Pat. No. 5,639,510 and U.S. Pat. No. 5,837,314.

### Definitions

As used herein “lens” refers to any ophthalmic device that resides in or on the eye. These devices can provide optical correction or may be cosmetic. For example, the term lens can refer to a contact lens, intraocular lens, overlay lens, ocular insert, optical insert or other similar device through which vision is corrected or modified, or through which eye physiology is cosmetically enhanced (e.g. iris color) without impeding vision. In some embodiments, the preferred lenses of the invention are soft contact lenses are made from silicone elastomers or hydrogels, which include but are not limited to silicone hydrogels, and fluorohydrogels.

As used herein, the term “lens forming mixture” or “Reaction Mixture” refers to a monomer or prepolymer material which can be cured, to form an ophthalmic lens. Various embodiments can include lens forming mixtures with one or more additives such as: UV blockers, tints, photoinitiators or catalysts, and other additives one might desire in an ophthalmic lenses such as, contact or intraocular lenses. Lens forming mixtures are more fully described below.

As used herein, the term “lens swelling material” refers to any material which has the effect of swelling the lens material. A lens swelling material may therefore include, for example: a diluent, a surfactant, a solvent and an alcohol, and any combination of lens swelling substances, or combination of lens swelling substance and a non lens swelling substance.

As used herein, the term “mold” refers to a rigid or semi-rigid object that may be used to form lenses from uncured formulations. Some preferred molds include two mold parts forming a front curve mold part and a back curve mold part.

As used herein, “released from a mold,” means that a lens is either completely separated from the mold, or is only loosely attached so that it can be removed with mild agitation or pushed off with a swab.

As used herein, the term “TPME” refers to Tri(Propylene Glycol) Methyl Ether.

### Molds

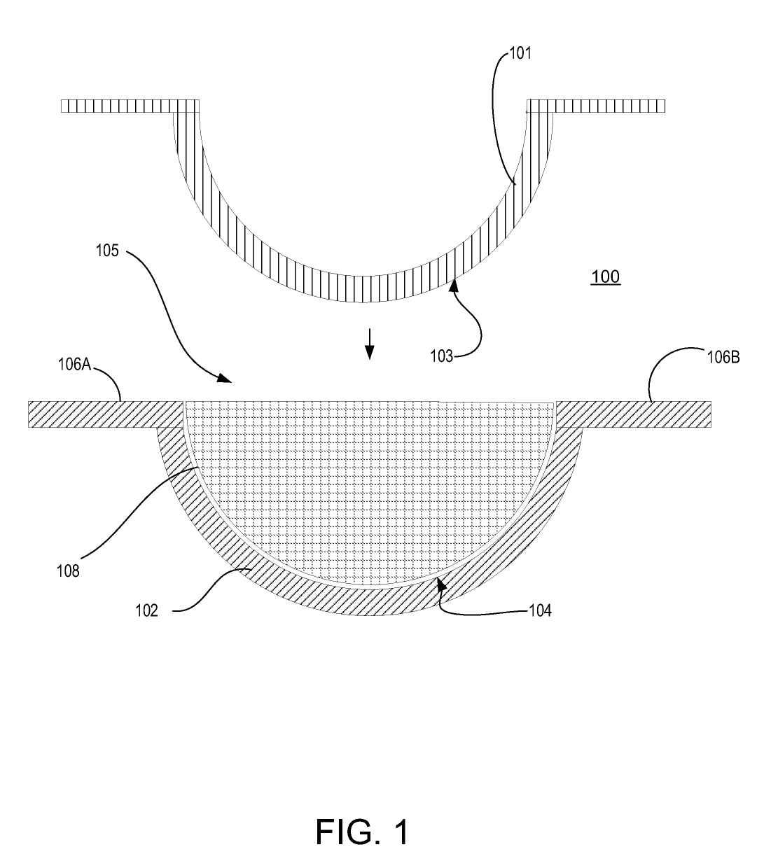

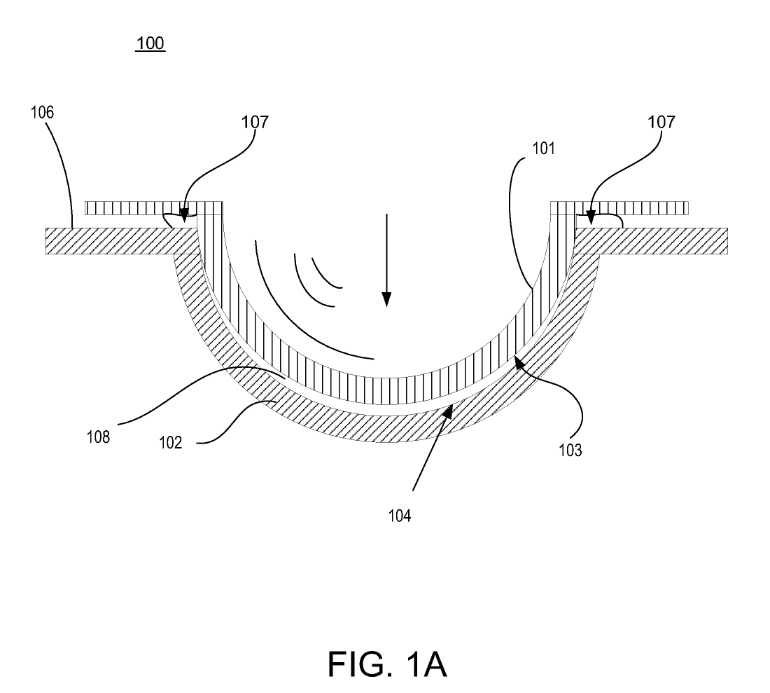

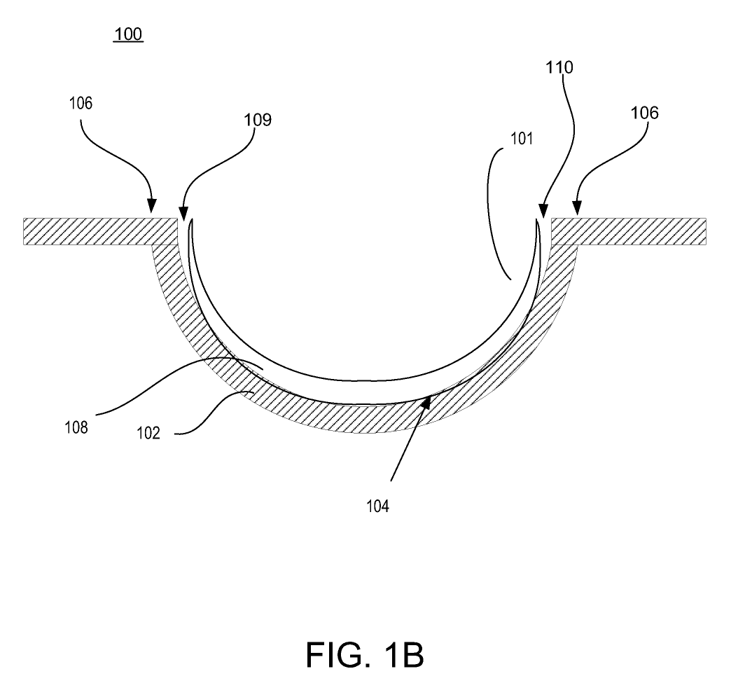

Referring now to FIG. 1, a diagram of an exemplary mold for an ophthalmic lens is illustrated. A mold assembly” is illustrated with a form 100 having a cavity 105 into which a lens forming mixture can be dispensed such that upon reaction or cure of the lens forming mixture, an ophthalmic lens 108 of a desired shape is produced. The molds and mold assemblies 100 of this invention are made up of more than one “mold parts” or “mold pieces” 101-102. The mold parts 101-102 can be brought together such that a cavity 105 is formed by combination of the mold parts 101-102 and a lens 108 can be fashioned in the cavity 105. This combination of mold parts 101-102 is preferably temporary.

At least one mold part 101-102 is designed to have at least a portion of its surface 103-104 in contact with the lens forming mixture such that upon reaction or cure of the lens forming mixture that lens forming surface 103-104 provides a desired shape and form to the portion of the lens with which it is in contact. The same is true of at least one other mold part 101-102. In addition, at least one mold part 101-102 will have a flange area 106 along the perimeter of the lens forming surface 103-104.

According to the present invention, the flange area 106, or other perimeter portion, receives application of a lens swelling material in order to facilitate release. In some preferred embodiments, a stamp of lens swelling material will be applied to the flange 106 following formation of the lens 108 and demold of the back curve mold part 101 from the front curve mold part 102 and the lens 108.

Thus, for example, in a preferred embodiment a mold assembly 100 is formed from two parts 101-102, a female concave piece (front curve mold part) 102 and a male convex piece (back curve mold part) 101 with a cavity 105 formed therebetween. The portion of the concave surface 104 which makes contact with Reaction Mixture has the curvature of the front curve of an ophthalmic lens 108 to be produced in the mold assembly 100 and is sufficiently smooth and formed such that the surface of a ophthalmic lens 108 formed by polymerization of the reaction mixture which is in contact with the concave surface 104 is optically acceptable.

The back curve mold part 101 has a convex surface 103 in contact which contacts the lens forming mixture and has the curvature of the back curve of a ophthalmic lens to be produced in the mold assembly 100. The convex surface 103 is sufficiently smooth and formed such that the surface of a ophthalmic lens formed by reaction or cure of the lens forming mixture in contact with the back surface 103 is optically acceptable.

In some embodiments, the lens forming surface 103-104 can have a geometry that is necessary to impart to the lens surface the desired optical characteristics, including without limitation, spherical, aspherical and cylinder power, wave front aberration correction, corneal topography correction and the like as well as any combinations thereof. Generally, the inner concave surface 104 of the front curve mold part 102 defines the outer surface of the ophthalmic lens 108, while the outer convex surface 103 of the back mold piece 101 defines the inner surface of the ophthalmic lens 108. A flange area 106 can be used to receive the lens swelling substance, and also to support the lens forming areas 103-104 and facilitate handling of the mold parts 101-102.

According to various embodiments, the molds of the invention may contain polymers such as polypropylene, polyethylene, polystyrene, polymethyl methacrylate, cyclic polyolefins and modified polyolefins. In addition, some embodiments can contain blends of polymers, such as, for example, a blend of the water soluble polymer and polypropylene (Zieglar Natta or metallocene catalyst process with nucleation) may be used, where the ratio by weight percentage of water soluble polymer to polypropylene ranges from about 99:1, to about 10:90 respectively. Such blends can be used on either or both mold parts 101-102. In some embodiments, it is preferred that such blend is used on the back curve and the front curve consists of a cyclic olefin.

In some embodiments, the molds of the invention may contain additives that facilitate the separation of the lens forming surfaces, reduce the adhesion of the cured lens to the molding surface, or both. For example, additives such as metal or ammonium salts of stearic acid, amide waxes, polyethylene or polypropylene waxes, organic phosphate esters, glycerol esters or alcohol esters may be added to the material used to form the mold parts 101-102 prior to forming the mold.

Examples of additives which may be added to the mold part material may include, but are not limited to: Dow Siloxane MB50-321 and Dow Siloxane MB50-321 (a silicone dispersion), Nurcrel 535 & 932 (ethylene-methacrylic acid co-polymer resin Registry No. 25053-53-6), Erucamide (fatty acid amide Registry No. 112-84-5), Oleamide (fatty acid amide Registry No. 301-02-0), Mica (Registry No. 12001-26-2), Atmer 163 (fatty alkyl diethanolamine Registry No. 107043-84-5), Pluronic (polyoxypropylene-polyoxyethylene block co-polymer Registry No. 106392-12-5), Tetronic (alkyoxylated amine 110617-70-4), Flura (Registry No. 7681-49-4), calcium stearate, zinc stearate, Super-Floss anti block (slip/anti blocking agent, Registry No. 61790-53-2), Zeospheres anti-block (slip/anti blocking agent); Ampacet 40604 (fatty acid amide), Kemamide (fatty acid amide), Licowax fatty acid amide, Hypermer B246SF, XNAP, polyethylene glycol monolaurate (anti-stat) epoxidized soy bean oil, talc (hydrated Magnsium silicate), calcium carbonate, behenic acid, pentaerythritol tetrastearate, succinic acid, epolene E43-Wax, methyl cellulose, cocamide (anti-blocking agent Registry No. 61789-19-3), poly vinyl pyrrolidinone (360,000 MW).

Referring now to FIG. 1A, a cross section of mold parts 101-102 as they are engaged with each other to form an ophthalmic lens 108. In addition, excess Reaction Mixture can be forced around the flange area 106 to create a HEMA ring 107.

Referring now to FIG. 1B, according to the present invention, the flange area 106 receives application of a lens swelling substance. The lens swelling substance can include, for example, TPME, alcohol, a surfactant, a surfactant substitute, or any other material or compound which can be applied to the mold so that it can come into contact with the newly formed lens and swell a portion of the lens, causing the swelled portion to separate from the mold part 102, as illustrated by the areas 109-110.

With a portion of the lens 108 separated from the mold part 102, hydration solution can enter into an area 109-110 between the lens 108 and the mold part 102 and continue to some portion of the lens 108 which is stilled adhered to the mold part 102 and facilitate full release of the lens 108 from the mold part 102.

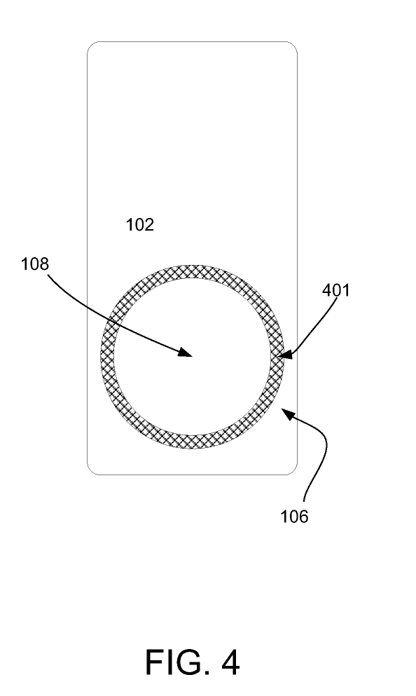

Referring now to FIG. 4, a top down view of a mold part according to the present invention is illustrated and additionally shows an area 401 that can receive a layer of lens swelling substance, such as through a stamping process. Other methods of application of a lens swelling substance can include, for example, spraying, micro dosing, dabbing or immersing. In some embodiments, spraying the lens swelling material can include jetting the lens swelling material in a controlled fashion via a piezo electric device, such as those known in the industry for ink jet application. Other embodiments may also include spraying techniques such as those utilized in commercial air brushing applications.

### Method Steps

Further this invention includes a method of making an ophthalmic lens with steps that facilitate release of a cured lens from a mold by stamping a portion of at least one of: the mold and the lens, with a lens swelling compound.

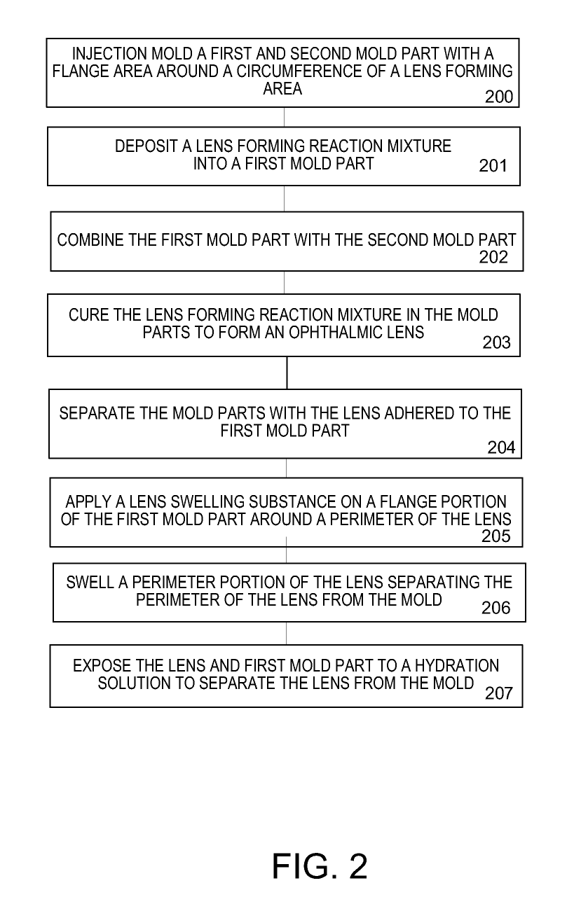

Referring now to FIG. 2, a flow diagram illustrates exemplary steps that may be implemented in some embodiments of the present invention. It is to be understood that some or all of the following steps may be implemented in various embodiments of the present invention.

At 200, injection molding processes are used to form one or more mold parts 101-102 which in turn may be used to manufacture an ophthalmic lens.

At 201, the Reaction Mixture is deposited into a first mold part 102, which is utilized to shape the ophthalmic lens 108.

At 202, the first mold part 102 can be combined with at least one other mold part 101-102 to shape the deposited Reaction Mixture into the desired shape of a biomedical device, such as an ophthalmic lens 108.

At 203, the Reaction Mixture is cured and formed into a lens 108. Curing can be accomplished, for example, by various means known in the art, such as, for example, exposure of the reaction mixture to actinic radiation, exposure of the reaction mixture to elevated heat (i.e. 40° C. to 75° C.), or exposure to both actinic radiation and elevated heat.

At 204, the mold parts 101-102 are separated. Following separation, the ophthalmic lens 108 will remain adhered to one of the mold parts 101-102. For example, in some preferred embodiments, following separation, the ophthalmic lens 108, will remain adhered to the front curve mold part 102.

At 205, a lens swelling substance, such as for example, TPME, is applied to a portion of the mold part for which it is desirable to reduce any adhesive force that may develop between the mold part and a Reaction Mixture deposited into the mold part 101-102. In some preferred embodiments, the lens swelling material is applied to a perimeter along an edge of the lens 108. Application of the lens swelling substance can be accomplished, for example, with a stamping apparatus, such as those described in U.S. Pat. No. 5,639,510. In various embodiments, it is possible to apply the lens swelling substance prior to deposition of he Reaction Mixture or, in some preferred embodiments, subsequent to deposition and cure of the Reaction Mixture.

At 206, the lens swelling substance will come into contact with a portion of the lens 108 and swell that portion of the lens. The swelling will cause at least a portion of the lens to separate from the mold in which the lens was formed. In some embodiments, the separation will include a scalloping of the lens, wherein a scallop includes alternating portions of the lens which are attached to the mold and portions which are separated from the mold along a perimeter of the lens edge, as further described below in regards to FIG. 4.

At 207, the lens 108 and mold part 102 are exposed to a hydration solution. The separated portion of the lens 108 from the mold par 102 provides a pathway for the hydration solution to enter in between the mold part 102 and the lens 108. As the hydration solution enters in between the lens 108 and the mold part 102 the hydration solution facilitates full release of the lens 108 from the mold part 102. In some embodiments, the hydration solution can be heated to further facilitate release of the lens 108 from the mold part 102. In some embodiments, the hydration solution can include a buffered aqueous solution.

### Apparatus

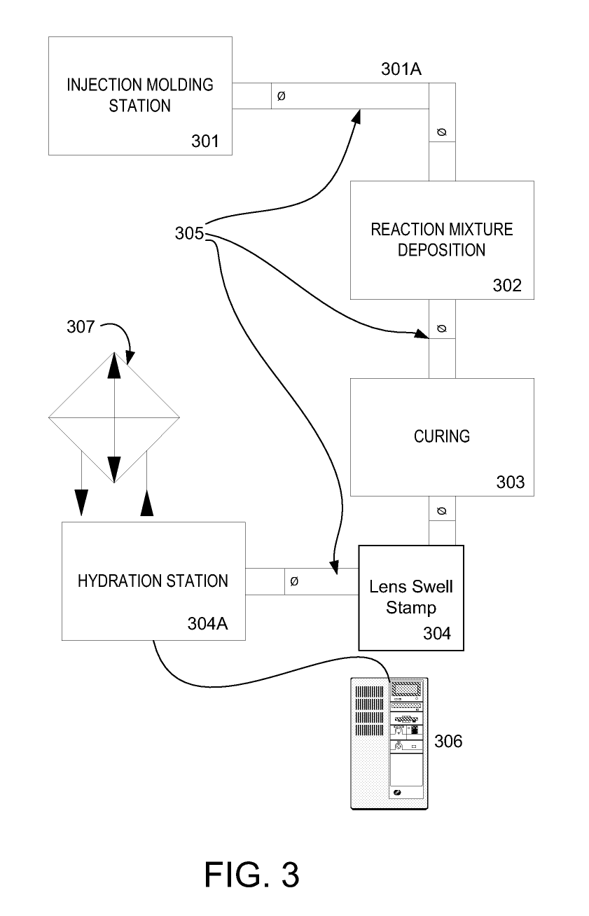

Referring now to FIG. 3, a block diagram is illustrated of apparatus contained in processing stations 301-304A that can be utilized in implementations of the present invention. In some preferred embodiments, processing stations 301-304A can be accessible to ophthalmic lenses 100 via a transport mechanism 305. The transport mechanism 305 can include for example one or more of: a robot, a conveyor and a rail system in conjunction with a locomotion means that may include, a conveyor belt, chain, cable or hydraulic mechanism powered by a variable speed motor or other known drive mechanism (not shown).

Some embodiments can include mold parts 101-102 placed in pallets (not shown). The pallets can be moved by the transport mechanism 305 between two or more processing stations 301-304A. A computer or other controller 306 can be operatively connected to the processing stations 301-304A to monitor and control processes at each station 301-304A and also monitor and control the transport mechanism 305 to coordinate the movement of lenses between the process stations 301-304A.

Processing stations 301-304A can include, for example, an injection molding station 301. At the injection molding station 301, injection molding apparatus forms mold parts 101-102 suitable for manufacturing a desired biomedical device, such as the ophthalmic lens 108.

Processing station 302 can include a deposition station, which deposits a quantity of a Reaction Mixture into the front curve mold portion 102, and preferably completely cover the lens forming mold surface 104 with the Reaction Mixture. The Reaction Mixture should comprise any material or mixture of materials, which upon polymerization yields an optically clear, integral shape-sustaining contact lens or contact lens precursor, such as, for example, a silicone hydrogel monomer or prepolymer.

A curing station 303 can include apparatus for polymerizing the Reaction Mixture. Polymerization is preferably carried out by exposing the Reaction Mixture to a source of initiation which can include for example, one or more of: actinic radiation and heat. Curing station 302 therefore includes apparatus that provide a source of initiation of the Reaction Mixture deposited into the front curve mold 102. In some embodiments, actinic radiation can be sourced from bulbs under which the mold assemblies travel. The bulbs can provide an intensity of actinic radiation in a given plane parallel to the axis of the bulb that is sufficient to initiate polymerization.

In some embodiments, a curing station 303 heat source can be effective to raise the temperature of the Reactive Mixture to a temperature sufficient to assist the propagation of the polymerization and to counteract the tendency of the Reaction Mixture to shrink during the period that it is exposed to the actinic radiation and thereby promote improved polymerization. Some embodiments can therefore include a heat source that can maintain the temperature of the Reaction Mixture (by which is meant that resin before it begins to polymerize, and as it is polymerizing) above the glass transition temperature of the polymerized product or above its softening temperature as it is polymerizing. Such temperature can vary with the identity and amount of the components in the Reaction Mixture. In general, some embodiments include apparatus capable of establishing and maintaining temperatures on the order of 40° C. degree to 75° C.

In some embodiments, a source of heat can include a duct, which blows warm gas, such as, for example, N₂ or air, across and around the mold assembly as it passes under the actinic radiation bulbs. The end of the duct can be fitted with a plurality of holes through which warm gas passes. Distributing the gas in this way helps achieve uniformity of temperature throughout the area under the housing. Uniform temperatures throughout the regions around the mold assemblies can facilitate more uniform polymerization.

In some embodiments, polymerization of Reaction Mixture can be carried out in an atmosphere with controlled exposure to oxygen, including, in some embodiments, an oxygen-free environment, because oxygen can enter into side reactions which may affect a desired optical quality, as well as the clarity of the polymerized lens. In some embodiments, the lens mold halves are also prepared in an atmosphere that has limited oxygen or is oxygen-free. Methods and apparatus for controlling exposure to oxygen are well known in the art.

A lens swelling station 304 applies a lens swelling material to a portion of the lens 108. As indicated above, in some preferred embodiments, the lens swelling station can include a stamp, which applies the lens swelling material, such as TPME, to a perimeter around the lens edge, thereby allowing the lens swelling material to migrate into contact with the lens. Other mechanisms that can be used to apply the lens swelling material can include, for example, a spraying unit, such as those utilized in ink jet applications, a swab, dipping the perimeter of the lens and mold part into a lens swelling material, a brush and micro dosing units.

The hydration station 304A can be used to expose the mold parts and newly formed lens to an aqueous solution. Some alternate embodiments can also include a demold station (not shown) to demold the mold parts 101-102 of those embodiments with a mold part with only some material which is water soluble.

In some embodiments, a heat exchanger (not illustrated) is used to maintain the temperature of the hydration solution at a temperature greater than typical ambient room temperature. For example, and without limitation, a heat exchanger can be used to raise the temperature of the hydration solution to about 60° C. to about 95° C.

### Lens Materials

Some preferred embodiments of the present invention can include lenses fashioned from a silicone hydrogel material. Examples of silicone containing monomers include SiGMA (2-propenoic acid, 2-methyl-, 2-hydroxy-3-[3-[1,3,3,3-tetramethyl-1-[(trimethylsilyl)oxy]disiloxanyl]propoxy]propyl ester), α,ω-bismethacryloxypropylpolydimethylsiloxane, mPDMS (monomethacryloxypropyl terminated mono-n-butyl terminated polydimethylsiloxane) and TRIS (3-methacryloxypropyltris(trimethylsiloxy)silane). Other silicone hydrogels are also within the scope of the present invention.

Other embodiments can include lenses fashioned from etafilcon A, genfilcon A, lenefilcon A, polymacon, acquafilcon A, balafilcon A, lotrafilcon A, galyfilcon A, and senofilcon A. Still other embodiments can include ophthalmic lenses made from prepolymers.

Referring now to FIG. 4, a block diagram of a lens 108 situated in a mold part 102 with a flange portion 106 is shown. In addition, a circumferential area 401 of the flange 106 is indicated which surrounds an edge of the lens 108. In some preferred embodiments, a lens swelling material is applied to the flange 106 in the circumferential area 401 which surrounds the lens 108. After application, the lens swelling material comes into contact with the lens 108 and causes the lens to swell. Contact of the lens swelling material to the lens can be attributed to flowing of the lens swelling material, or other migration. In some embodiments, the lens swelling material is applied directly to some portion of the lens 108, such as a circumferential area of the lens 108 about the edge of the lens 108.

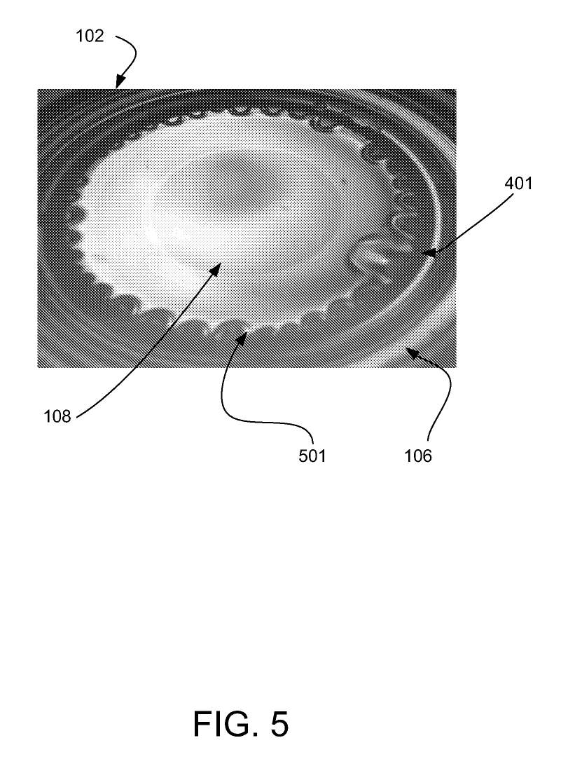

Referring now to FIG. 5, a lens is illustrated following application of the lens swelling material, which in some embodiments causes scalloping (as illustrated). The scalloped area of the lens 501 includes that portion of the lens 108 which has separated from the mold part 102 along the edge of the lens 108.

In some embodiments, a sufficient amount of lens swelling material can be applied to cause 50% or more of the edge area of the lens 501 to scallop. Other preferred embodiments can include application of a sufficient amount of lens swelling material to cause 75% or more of the edge area 501 of the lens 108 to separate and thereby scallop, and still other embodiments can cause 90% or more of the edge area 501 of the lens 108 to separate and thereby scallop.

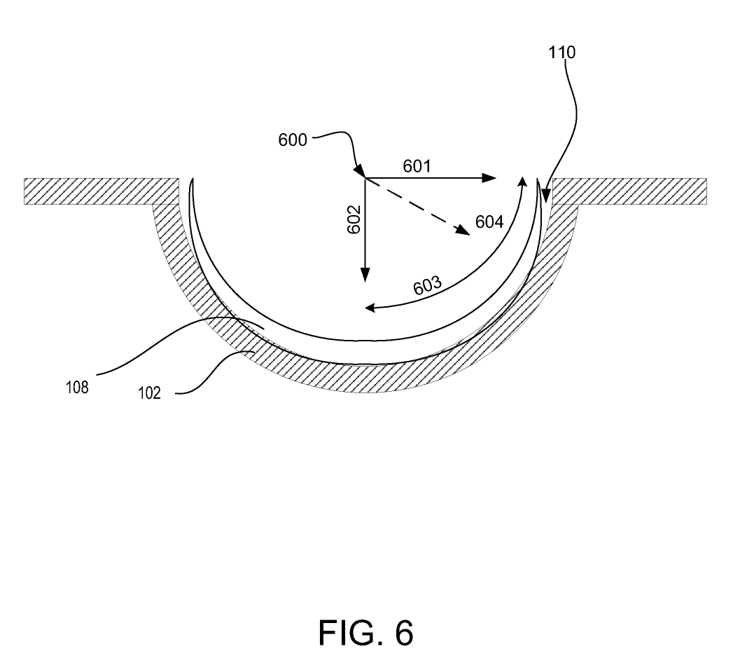

In another aspect, and referring now to FIG. 6, a degree of lens 1008 portion separation or scalloping 110 away from a mold part 102 caused by application of a lens swelling material can be indicated according to a number of degrees in an arc 603 of separation of the lens 108 from the mold part 102. The arc 603 can be formed between rays diverging from a center point defined by the semicircle circle formed by the lens 108. For example, in some embodiments of the present example, a sufficient amount of lens swelling material can be applied to one or more of: the mold part 102 and the ophthalmic lens 108 lens to cause an arc of 45° or less of separation. Other embodiments can include, for example, application of a sufficient amount of lens swelling material can be applied to one or more of: the mold part 102 and the ophthalmic lens 108 lens to cause an arc of 30° or less, still other embodiments may only require 10° or less.

Accordingly, the present invention provides methods and apparatus for facilitating release of a lens from a mold part. While the present invention has been particularly described above and drawings, it will be understood by those skilled in the art that the foregoing ad other changes in form and details may be made therein without departing from the spirit and scope of the invention, which should be limited only by the scope of the appended claims.

What is claimed is:

1. A method of reducing the adherence of a cured ophthalmic lens to a portion of a mold part used to fashion an ophthalmic lens, the method comprising:
applying a lens swelling material to a portion of the formed lens thereby causing some portion of the lens to separate from the mold part while a remaining portion is adhered to the mold part;
exposing the lens and mold part to a hydration solution whereby the hydration solution enters into a space between the lens and the mold part; and
releasing the lens from the mold part while the lens and mold part are exposed to the hydration solution.

2. The method of claim 1 wherein the step of applying the lens swelling material to a portion of the formed lens comprises application of the lens swelling material to a circumferential flange surface of the mold, wherein the circumferential flange borders an edge of the lens, and allowing the lens swelling material to migrate into contact with the lens.

3. The method of claim 1 wherein the step of applying the lens swelling material comprises stamping the lens swelling material onto at lest one of: the lens and a portion of the mold adjacent to the lens.

4. The method of claim 1 wherein the step of applying the lens swelling material comprises jetting the lens swelling material onto at lest one of: the lens and a portion of the mold adjacent to the lens.

5. The method of claim 1 wherein the step of applying the lens swelling material comprises micro dosing the lens swelling material onto at lest one of: the lens and a portion of the mold adjacent to the lens.

6. The method of claim 1 wherein the lens swelling material comprises Tri(Propylene Glycol) Methyl Ether.

7. The method of claim 1 wherein the lens swelling material comprises alcohol.

8. The method of claim 1 wherein the lens swelling material comprises a surfactant.

9. The method of claim 6 wherein the amount of lens swelling mixture applied is about 10 mg or less.

10. The method of claim 6 wherein the lens swelling material comprises an aqueous solution comprising between about 0.5% and 15% Tri(Propylene Glycol) Methyl Ether.

11. The method of claim 6 wherein the lens swelling material comprises an aqueous solution comprising between about 0.1% and 5% Tri(Propylene Glycol) Methyl Ether.

12. The method of claim 6 wherein the lens swelling material comprises between about 75% and 100% Tri(Propylene Glycol) Methyl Ether.

13. The method of claim 12 additionally comprising the step of heating the hydration solution to a temperature of about 85° C. or more.

14. The method of claim 13 wherein the hydration solution comprises a buffered aqueous solution.

15. The method of claim 1 wherein the lens comprises a silicone hydrogel.

16. The method of claim 1 wherein the mold part comprises a cyclic olefin.

17. The method of claim 1 wherein the mold part comprises polystyrene.

18. A molding combination for forming an ophthalmic lens, the combination comprising:
a mold portion comprising a lens forming surface;
a cured lens portion adhered to the lens forming surface; and
a cured lens portion scalloped away from the lens forming surface.

19. The molding combination of claim 18 wherein the lens portion scalloped away from the lens forming surface comprises an arc of 45° or less from an edge of the ophthalmic lens.

20. The molding combination of claim 18 additionally comprising a lens swelling material in contact with the cured lens portion scalloped away from the lens forming surface.
